(19) United States
(12) Patent Application Publication
(10) Pub. No.: US 2004/0179557 A1
(43) Pub. Date: Sep. 16, 2004

(54) Channel structures, systems, and methods to support high speed communication channels

(76) Inventors: Wen Tong, Ottawa (CA); Shiquan Wu, Nepean (CA); Mo-Han Fong, L'Original (CA); Jun Li, Richardson, TX (US)

Correspondence Address: DOWELL & DOWELL PC, SUITE 309, 1215 JEFFERSON DAVIS HIGHWAY, ARLINGTON, VA, 22202

(21) Appl. No.: 10/799,684

(22) Filed: Mar. 15, 2004

Related U.S. Application Data
(60) Provisional application No. 60/454,351, filed on Mar. 14, 2003.

(51) Int. Cl. H04J 3/02

(52) U.S. Cl. 370/537

(57) ABSTRACT

Communication methods, systems and related communication channel structures, particularly suited to high data rate communication channels, are provided. A first communication signal is multiplexed with both a second communication signal according to a first multiplexing technique and a third communication signal according to a second multiplexing technique. According to one embodiment, the communication signals are CDM (Code Division Multiplexing) signals, whereas the first communication technique is TDM (Time Division Multiplexing). In such an embodiment, TDM techniques may be used, for example, to effectively increase the spreading factor for a control channel at high data rates, which are normally associated with low spreading factors.

### CROSS-REFERENCE TO RELATED APPLICATION

This application claims priority from U.S. provisional patent application Serial No. 60/454,351, filed on Mar. 14, 2003. The entire contents of this provisional application are hereby incorporated herein by reference.

### FIELD OF THE INVENTION

The invention relates to communications, and in particular to channel structures, systems, and methods to support high speed communication channels, for high speed packet data operation in CDMA (Code Division Multiple Access) systems for instance.

### BACKGROUND OF THE INVENTION

Reverse link (RL) channels that have been defined for one known type of communication system, illustratively CDMA2000™ systems, are listed in Table 1, at the end of the description of preferred embodiments below. As shown at the bottom of Table 1, several new physical RL channels have recently been defined.

The R-ESCH (Reverse Enhanced Supplemental Channel) is a new RL channel for RL high-speed packet data operation. The three channels shown below the R-ESCH in Table 1 are new control channels added on the RL to support the R-ESCH operation. The R-RRCH (Reverse Rate Request Channel) carries a rate requested by a communication terminal, generally referred to as a mobile station or MS. The R-RICH (Reverse Rate Indicator Channel) carries data rate or MCS (modulation/coding set) information of a corresponding R-ESCH frame. The R-HICH (Reverse H-ARQ (Hybrid Automatic Repeat Request) Indicator Channel) carries the HARQ information of the corresponding R-ESCH frame. Although these channels are defined in CDMA2000 standards, implementation details of these channels have not been defined.

The R-ESCH and its associated channels are applicable for the 1x-EV-DV and 1x-EV-DO RL enhancement and evaluation. The development of such an enhanced R-ESCH is intended to support reverse link high speed packet data operation. In general, the R-ESCH can be used for high speed packet transmission, such that the data rate is dynamically variable, and supports adaptive coding modulation and power allocation based on the packet data rate. However, the demodulation of R-ESCH requires an additional auxiliary pilot channel or information in addition to the existing common pilot channel R-PICH (Reverse Pilot Channel).

In order for a base station (BS) or another network element in a communication network to properly decode an R-ESCH frame, two basic pieces of information for the R-ESCH frame are needed, including the channel configuration parameters of the R-ESCH, such as modulation type and coding rate for instance, and the channel characteristics experienced on a communication channel on which the R-ESCH frame is received.

One solution for transferring channel configuration parameters to a BS is to design a separate reliable channel such as the R-RICH in Table 1 to carry data rate or MCS information to the BS. One common solution is to provide a pilot signal or a training sequence that the BS can utilize for channel estimation, and thus coherent detection of R-ESCH. Such a pilot channel or training sequence represents system overhead. According to one technique, a CDM (Code Division Multiplexing) pilot channel at a power level proportional to the R-ESCH data rate is provided. However, as a high data rate implies a lower spreading factor for such a channel, inter-code interference becomes a major issue when performing channel estimation and decoding.

### SUMMARY OF THE INVENTION

According to one aspect, the invention provides a method which includes multiplexing a first communication signal with a second communication signal according to a first multiplexing technique, and multiplexing the first communication signal with a third communication signal according to a second multiplexing technique.

The multiplexing of the first communication signal with the third communication signal may precede the multiplexing of the first communication signal with the second communication signal. In this instance, the multiplexed first communication signal and third communication signal are multiplexed with the second communication signal. Interspersed multiplexing operations are also possible, where the first, second, or both multiplexing techniques include more than one multiplexing operation.

In a preferred embodiment, the first communication signal is punctured at multiple time positions, and portions of the second communication signal inserted into the punctured positions. A puncturing ratio of the puncturing may be fixed or variable. If not all of the punctured positions are used for the portions of the second communication signal, portions of the third communication signal may be inserted into unused punctured positions into which no portions of the second communication signal have been inserted. In one embodiment, the third communication signal is also punctured at the time positions.

According to a further embodiment, the first communication signal is associated with a data channel, and the second communication signal is associated with a pilot channel which carries pilot information for use in coherent detection of the data channel.

In a particularly preferred embodiment, the first, second, and third communication signals are CDM signals and the first multiplexing technique is TDM (time division multiplexing).

Adaptive power allocation may also be employed. For example, a power level of the third communication signal may be determined, and power allocation to the first communication signal and the second communication signal may then be based on the power level of the third communication signal.

At a receiver to which a multiplexed signal including the first communication signal multiplexed with the second communication signal according to the first multiplexing technique and with the third communication signal according to the second multiplexing technique is transmitted, the multiplexed signal is preferably received and demultiplexed according to a demultiplexing technique corresponding to the first multiplexing technique to recover the second communication signal.

The invention also provides, in another aspect, a method which includes receiving and demultiplexing a multiplexed signal. The multiplexed signal includes a first communication signal multiplexed with a second communication signal according to a first multiplexing technique and with a third communication signal according to a second multiplexing technique. A demultiplexing technique corresponding to the first multiplexing technique is then used to recover the second communication signal.

A system in accordance with a further aspect of the invention includes an input for receiving first, second, and third communication signals and a processor configured to multiplex the first communication signal with the second communication signal according to a first multiplexing technique and to multiplex the first communication signal with the third communication signal according to a second multiplexing technique. The processor may implement a puncturer configured to puncture the first communication signal and a multiplexer configured to insert portions of the second communication signal into punctured positions of the first communication signal.

There is also provided, in yet another aspect of the invention, a system including an input for receiving a multiplexed signal comprising a first communication signal multiplexed with a second communication signal according to a first multiplexing technique and with a third communication signal according to a second multiplexing technique, and a processor configured to demultiplex the multiplexed signal according to a demultiplexing technique corresponding to the first multiplexing technique to recover the second communication signal.

These systems may be implemented in a communication terminal and a network element of a communication network to support multiplexing according to the first and second multiplexing techniques for reverse link communications, forward link communications, or both, in the communication network.

In a still further aspect, the invention provides a communication channel structure. The channel structure includes a first communication channel having punctured positions forming a punctured communication channel multiplexed with the first communication channel according to a first multiplexing technique, a second communication channel, and a third communication channel. The first and third communication channels are adapted for multiplexing according to a second multiplexing technique. Information from the second communication channel is inserted into the punctured communication channel.

According to a preferred embodiment, the first communication channel is an R-ESCH, and the second communication channel is an R-RICH or an R-PDPICH (Reverse Packet Data Pilot Channel).

Embodiments of the invention provide for more reliable channel estimation for high data rate channels. For example, in a CDMA system, the use of TDM techniques for a control channel effectively increases the spreading factor for the control channel for high data rates.

Other aspects and features of embodiments of the present invention will become apparent to those ordinarily skilled in the art upon review of the following description of the specific embodiments of the invention.

### BRIEF DESCRIPTION OF THE DRAWINGS

Embodiments of the invention will now be described in greater detail with reference to the accompanying diagrams, in which:

FIG. 1 is a block diagram illustrating an example channel structure;

FIG. 2 is a flow diagram showing a method of processing the channels shown in FIG. 1;

FIG. 3 is a block diagram illustrating another example channel structure;

FIG. 4 is a flow diagram showing a method of processing the channels shown in FIG. 3;

FIG. 5 is a block diagram of a channel structure according to an embodiment of the invention;

FIG. 6 is a block diagram of a channel structure according to another embodiment of the invention;

FIG. 7 is a flow chart of a method according to an embodiment of the invention;

FIG. 8 is a flow chart of a method according to further embodiment of the invention;

FIG. 9 is a block diagram of a system in accordance with an embodiment of the invention; and

FIG. 10 is a block diagram of a system in accordance with another embodiment of the invention.

### DETAILED DESCRIPTION OF THE PREFERRED EMBODIMENTS

As described above, techniques for providing information relating to RL channels to a network element such as a base station in a communication network may be prone to inter-code interference and introduce significant overhead.

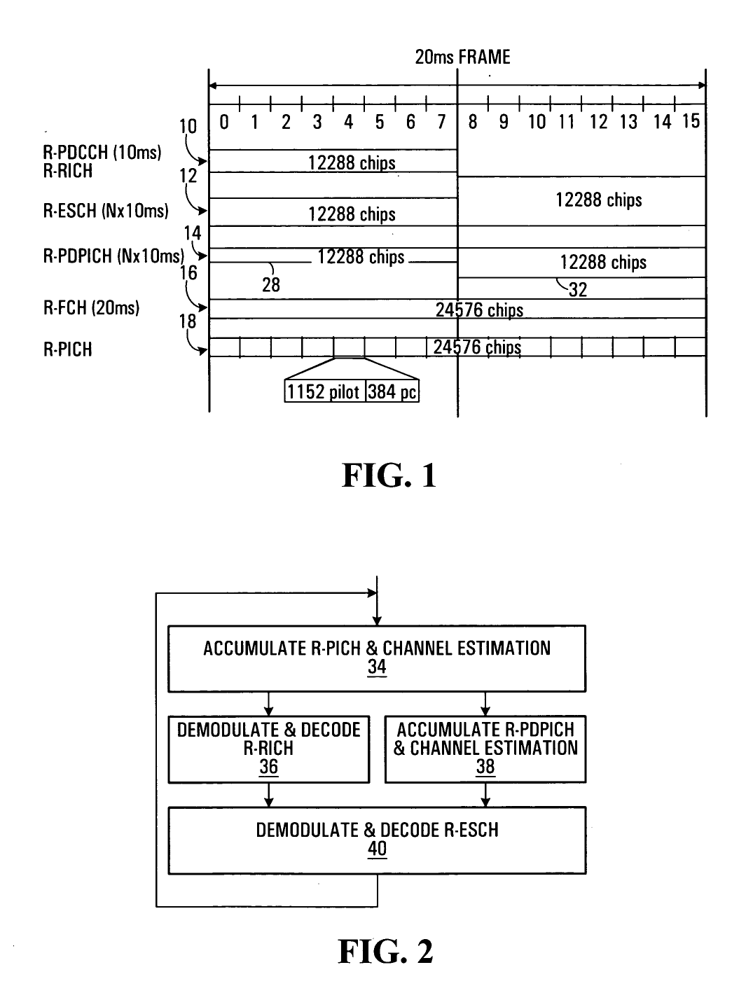

FIG. 1 is a block diagram illustrating an example channel structure according to one such technique. Those skilled in the art will be familiar with the channel structure of FIG. 1 and the operation and processing of those channels, which are therefore described only briefly herein.

As shown, the example channel structure includes an overlapping R-PDCCH (Reverse Packet Data Control Channel) and R-RICH 10, an R-ESCH 12, an R-PDPICH (Reverse Packet Data Pilot Channel) 14, an R-FCH (Reverse Fundamental Channel) 16, and a common pilot channel R-PICH (Reverse Pilot Channel) 18. Those skilled in the art will appreciate that the relatively high processing gain associated with the R-PDCCH and R-RICH allow these channels to overlap, as shown at 10.

In the channel structure of FIG. 1, the R-RICH, the R-ESCH 12, and the R-PDPICH 14 are all CDM-based. The R-PDPICH 14 is a special auxiliary pilot channel with a power allocation depending on the data rate of R-ESCH 12, as indicated by the different power levels 28 and 32. The different power levels of the R-ESCH 12 are associated with different data rates. As described above, power allocation to the R-ESCH 12 may be based on a data rate.

FIG. 2 is a flow diagram showing a method of processing the channels shown in FIG. 1. At a receiving end of an RL, a network element of a communication network, for example, the common pilot channel R-PICH is accumulated at 34 for channel estimation and used to demodulate and decode the R-PDCCH, which is in turn used to extract data rate information for the R-ESCH from the R-RICH at 36. At 38, the auxiliary pilot channel R-PDPICH is accumulated and used for channel estimation. Auxiliary pilot channel-based estimation is particularly important for higher data rates at which channel estimation based only on the common pilot channel R-PICH tends not to be effective. The R-ESCH is then demodulated and decoded at 40.

In general, transmit power at an MS is limited, such that channel estimation becomes especially challenging for the reliable detection of high speed data packets on a reverse channel in the presence of multipath fading. In addition, since the R-ESCH is intended primarily for high data rates and thus low spreading factors, inter-code/inter-chip interference may impair channel reception at a communication network element.

Although the above channel structure provides an auxiliary pilot channel R-PDPICH for improved channel estimation, the CDM-based R-RICH may interfere with the R-ESCH 12, particularly for high data rates and low spreading factors. The auxiliary CDM pilot channel R-PDPICH 14 also represents overhead and consumes reverse channel power, such that less power can then be allocated to the R-ESCH 12, and is another CDM pilot channel which may interfere with both the R-RICH and the R-ESCH 12.

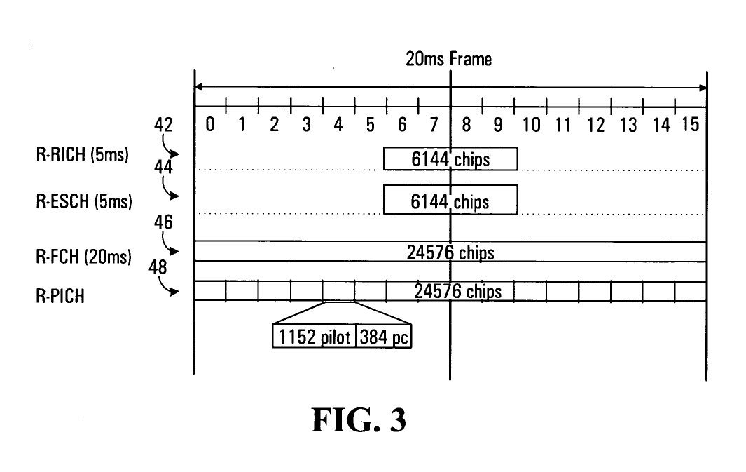

FIG. 3 is a block diagram illustrating another example physical channel structure, which eliminates the separate auxiliary pilot channel. In FIG. 3, a CDM R-RICH 42, a CDM R-ESCH 44, an R-FCH 46, and an R-PICH 48 are shown. The R-RICH 42 and the R-ESCH 44 have a power allocation based on a transmitted data rate.

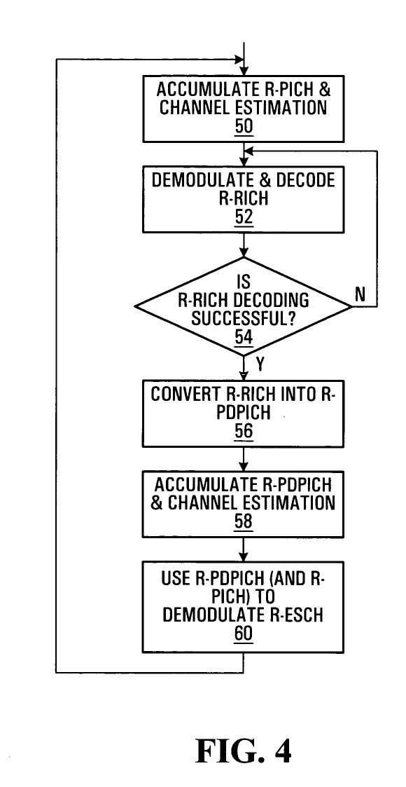

FIG. 4 is a flow diagram showing a method of processing these channels at a receiver on an RL. At an RL receiver, typically a base station or other communication network element, the R-PICH is accumulated for channel estimation at 50. The R-RICH is demodulated and decoded at 52 to extract the transmitted data rate information for the R-ESCH, and repeated if necessary as indicated at 54. At 56, the encoded/spread bits of the R-RICH are re-generated to effectively convert the R-RICH into auxiliary pilot channel information labelled R-PDPICH, as above. R-PDPICH is accumulated at 58 for channel estimation, and the re-generated R-PDPICH and R-RICH are used to demodulate the R-ESCH at 60.

In this scheme, the separate transmission of the auxiliary pilot channel R-PDPICH is avoided. However, the R-RICH is a CDM-based channel and thus may cause and be affected by interference.

According to an aspect of the invention, control information is embedded into a data channel or signal using a different multiplexing technique than is used or intended to be used for the data channel or signal. For example, in one embodiment, a Time Division Multiplex (TDM) pilot structure is provided to support the coherent detection of the R-ESCH on a reverse link of a CDMA system. In such an embodiment, CDM techniques are used for multiplexing data channels and possibly other channels, whereas TDM techniques are used to multiplex pilot information onto a signal. The signal onto which the pilot information is multiplexed may itself be a multiplexed signal that includes a number of signals or a signal that is intended for multiplexing or combination with other signals for transmission to a receiver.

Pilot channel multiplexing schemes according to embodiments of the invention provide for more effective channel estimation in high data rate conditions by reducing inter-code interference. Time multiplexing of the pilot channel and the R-ESCH effectively increases the spreading factor of the pilot channel information relative to data carried on the R-ESCH, thereby reducing the effects of inter-code interference on the pilot channel.

The pilot channel may be a stand-alone auxiliary pilot channel, such as the R-PDPICH above for RL communications in a CDMA communication system for instance, which contains information that is known to a receiver. Channel estimation at the receiver is then performed by accumulating the known pilot channel information. In another embodiment, the pilot channel embeds additional control information, illustratively the R-RICH channel. Where the pilot carries the embedded R-RICH or other control information, signalling overhead and interference may be reduced, since the R-RICH need no longer be transmitted separately.

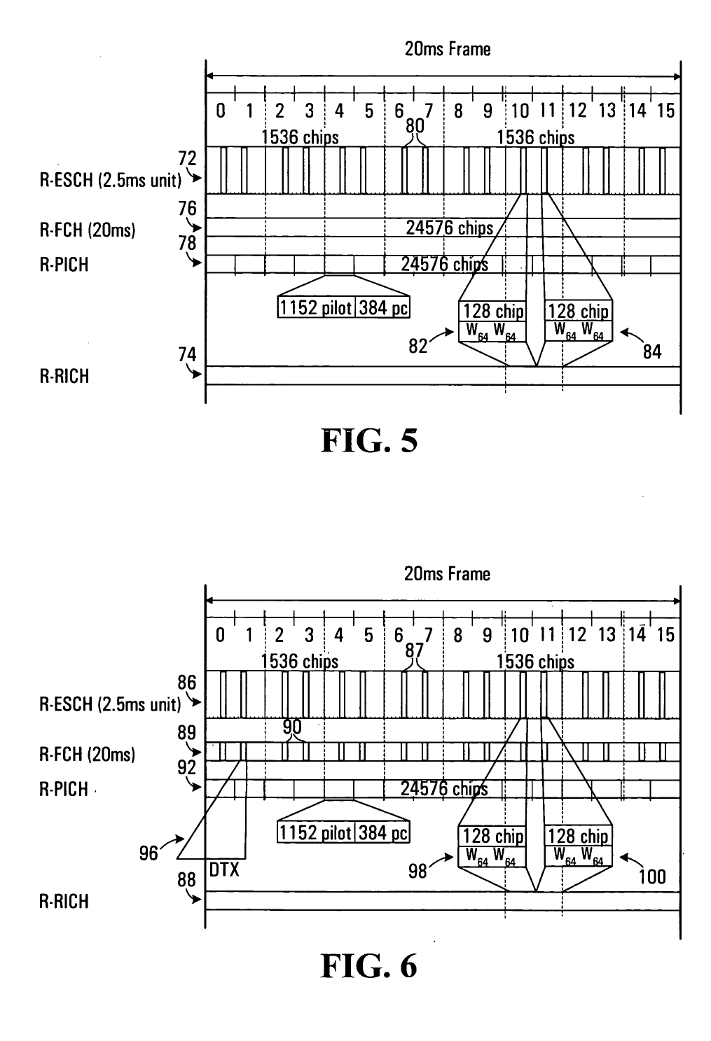

FIG. 5 is a block diagram of a channel structure according to an embodiment of the invention, including the R-ESCH 72, the R-RICH 74, the R-FCH 76, and the R-PICH 78. The R-FCH 76 and the common pilot channel R-PICH 78 are existing RL CDMA channels with which those skilled in the art will be familiar.

It should be appreciated that the particular channels and structure shown in FIG. 5 are intended solely for illustrative purposes and represent one embodiment of the invention, which is no way limited to any specific channel structure. Embodiments of the invention may be implemented in conjunction with other types of channels, including forward link channels, and in other types of systems than CDMA systems.

For example, the 20 ms frame having 16 time slots is representative of one frame structure that is used in one type of communication system. As will become apparent from the following description, multiplexing techniques according to embodiments of the invention are not dependent upon any particular frame type or duration. In addition, the R-ESCH 72 is an illustrative example of a high data rate channel to which the invention may be applied. Control information may be multiplexed with other types of channel to provide additional control information to a receiver and/or to reduce signalling overhead.

An R-ESCH may have a fixed or variable frame size. In FIG. 5, the R-ESCH 72 has a frame size of 20 ms, including 16 1.25 ms time slots numbered 0 through 15. Other R-ESCH frame durations, such as 2.5 ms, 5 ms, 10 ms, and 15 ms, for example, are also possible.

The R-RICH 74 carries data rate information associated with a next frame to be transmitted on the R-ESCH 72. The data rate information is preferably only sent if a transmitter, illustratively an MS for communications on the R-ESCH 72 is scheduled to transmit on the next frame boundary on the R-ESCH 72. In a preferred embodiment, the R-ESCH 72 is a packet data channel that is scheduled according channel quality, where channel quality is sufficient to allow allocation of transmit power to the R-ESCH 72. Poor channel conditions may require allocation of transmit power to primary channels such as the R-FCH 76 to such an extent as to preclude the transmission of the R-ESCH 72 and any other supplementary channels.

In FIG. 5, 4 Walsh codes encode 4 information bits to indicate one of 16 different MCS/data rates, although other numbers of bits and MCS/rates may instead be employed. This 4-bit information is mapped onto the R-RICH 74, for example using a Hadamard waveform transformation by a code, illustratively a Walsh code of length 64. An example mapping or coding between MCS information and Walsh codes is shown in Table 2 below. In the mapping scheme shown in Table 2, the MCS information bits 0000 are mapped to the code sequence shown in FIG. 5, W₆₄ W₆₄ W₆₄ W₆₄. It should be appreciated, however, that other types and lengths of codes and other types of mapping or transformation may also be used.

According to an embodiment of the invention, the R-RICH 74 is time multiplexed with the R-ESCH 72. The R-ESCH 72 is punctured at positions 80 to create a TDMA channel for insertion of the code sequence or coded symbol W₆₄ W₆₄ W₆₄ W₆₄ 82, 84. In the embodiment of FIG. 5, the coded symbol 82, 84 is multiplexed onto 2.5 ms units of the R-ESCH 72, as one block of 128 chips (2 64-bit codes) per 1.25 ms time slot. Thus, each 2.5 ms unit of the R-ESCH 72 carries a coded symbol of the R-RICH 74. The information of the R-RICH 74 that is multiplexed with the R-ESCH 72 is preferably transmitted at the same power level as the R-ESCH 72.

Since the R-ESCH 72 and the pilot channel, which embeds information from the R-RICH 74 in FIG. 5, are time-multiplexed, they can share the same Walsh code branch for Walsh spreading.

Although only one instance of the R-RICH coded symbol 82, 84 is shown in FIG. 5, the coded symbol is preferably time multiplexed at each time position 80 of the punctured TDMA channel within the R-ESCH 72, to provide time diversity, for example. It is also contemplated that R-RICH coded symbols may be multiplexed onto predetermined ones of the positions 80, such as those in the first 5 ms of the 20 ms R-ESCH frame, for instance. In this case, any punctured positions of the R-ESCH 72 that are not used for transmission of R-RICH information may be exploited for further signalling. For example, other control information, or even data, may be embedded into the R-ESCH 72 at such unused positions.

As described above, the techniques described herein may be used to insert a stand-alone pilot channel or a pilot channel that embeds information from another channel, the R-RICH in FIG. 5. For a stand-alone pilot channel, known bit patterns are encoded, preferably by Walsh spreading, into a desired chip rate and time multiplexed with the R-ESCH in predetermined positions. In one embodiment, this pilot channel occupies 128 chips per 1.25 ms slot as shown in FIG. 5, with the exception that coded predetermined bit patterns are carried by the pilot channel instead of R-RICH information. The predetermined bit patterns may also be distributed over multiple time slots, such as the 2.5 ms units of FIG. 5.

It should be appreciated that puncturing is an illustrative example of a technique that provides for time multiplexing of signals in accordance with embodiments of the invention. Although puncturing provides for backward compatibility in that puncturing does not change the format or protocols associated with a communication signal, a CDM signal in a preferred embodiment, other approaches may be applied where backward compatibility is not a design constraint, such as to create transmission gaps during generation of a communication signal.

In the above embodiment, a scheme is provided that time-multiplexes the R-ESCH 72 with control information, while keeping all other channels such as R-FCH 76 unchanged. FIG. 6 is a block diagram of a channel structure according to another embodiment of the invention, in which other channels are punctured.

The channel structure shown in FIG. 6 is substantially similar to that of FIG. 5, including the R-ESCH 86 with punctured positions 87 for the codes 98 and 100, the R-RICH 88, the R-FCH 89, and the common pilot channel R-PICH 92. However, in accordance with an aspect of the invention, the R-FCH 89 is also punctured at positions 90 corresponding to the punctured positions 87 of the R-ESCH 86. In the illustrated example, the punctured positions 90 of the R-FCH 89 are not replaced with any other signals or information, as indicated by the DTX (discontinued transmission) 96. During the DTX 96, at each punctured position 90, the R-FCH 89 is effectively muted. This allows the implementation of an advanced R-ESCH receiver at a receive side, at a base station or other network element of a communication system for instance. Other channels may also be punctured in a similar manner. Puncturing of one or more channels in addition to the R-ESCH 86 at positions coincident with a TDM pilot channel provide for more reliable reception of the TDM pilot channel, in that fewer channels are transmitted at the same times as the pilot channel.

According to an alternative embodiment, the total transmitted power of the R-RICH data could be effectively boosted by inserting the R-RICH data into punctured positions of both the R-ESCH 86 and the R-FCH 89. Instead of DTX at 96, the R-FCH then also carries R-RICH data at the punctured positions 90.

In the embodiments of the invention described above, auxiliary pilot channel information is time multiplexed as a pair of codes per time slot, with consecutive pairs of adjacent time slots carrying a code symbol. It should be appreciated, however, that other multiplexing schemes are also contemplated. For example, to provide even greater spreading of the pilot channel information, coded symbols could be spread over 5 ms units of the R-ESCH. According to one embodiment, each of 4 bits of MCS information is mapped to a pair of 64-bit Walsh codes. These codes are then inserted into respective punctured positions in four time slots, which for the frame structures of FIGS. 5 and 6 represents a 5 ms unit. Similarly, the puncturing ratio which defines the amount of puncturing need not be fixed as shown in FIGS. 5 and 6; variable puncturing ratios are also possible. The invention is in no way limited to these or any other specific codes, mappings, number of slots per coded symbol, or number of punctured positions, or to any particular numbers of bits, codes, slots, or punctured positions. Further variations of the techniques described herein will be apparent to those skilled in the art.

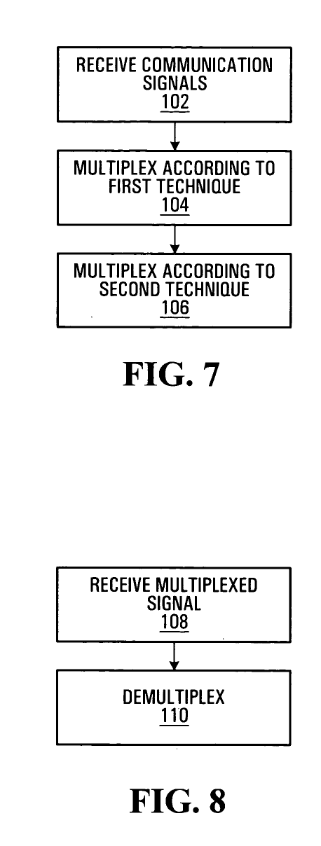

FIG. 7 is a flow chart of a method according to an embodiment of the invention. The method of FIG. 7 represents operations performed at a transmitter for multiplexing control information onto another channel. At 102, communication signals, illustratively CDM signals, are received from a signal generator or other component at a transmitter. The signals may be locally generated at the transmitter or received from a remote site for subsequent transmission. The communication signals may include signals for transmission on data channels, other types of signal such as control channel signals, for example, or some combination of different types of signals.

At 104, a first communication signal is multiplexed with at least a second communication signal according to a first multiplexing technique, and at 106, the first communication signal is multiplexed with at least a third communication signal. In the above embodiments, the first multiplexing technique is TDM, whereas the second multiplexing technique is CDM. The multiplexing at 104 preferably includes puncturing the first communication signal and inserting portions of the second communication signal, illustratively a pilot channel signal, into punctured positions of the first communication signal. In a CDMA system, the multiplexing at 106 preferably includes signal combining.

It should be appreciated, however, that the invention is in no way limited to this particular order of multiplexing. In the context of the above embodiments of the invention, CDM operations may be performed at step 104, followed by TDM operations at 106. Multiplexing operations may also be interspersed as described above. For CDMA communications, for example, communication signals are spread using CDMA techniques and then combined for transmission. In such a transmitter, the communication signals received at 102 have preferably already been spread but not yet combined with other signals.

The multiplexing at 104 and 106 may be performed at a transmitter by the same communication circuitry, a digital signal processor (DSP) or a processor in a communication terminal, for example. Thus, it should be appreciated that the first and second multiplexing techniques may be integrated into a single processor, or implemented separately in different elements or even in different communication devices. At some point after 106, a resultant multiplexed communication signal is preferably transmitted to a receiver. Transmission need not necessarily occur immediately after multiplexing. The multiplexed signal may be stored, for example, for later transmission.

FIG. 8 is a flow chart of a method according to further embodiment of the invention. Whereas FIG. 7 represents transmit-side operations, FIG. 8 illustrates receive-side operations.

A multiplexed signal received at 108 includes communication signals that have been multiplexed using different multiplexing techniques. At 110, the multiplexed signal is demultiplexed to recover one or more of the communication signals. The demultiplexing at 110 may involve a demultiplexing technique corresponding to one or both of the first multiplexing technique and the second multiplexing technique. In the above embodiment of the invention in which the R-RICH is multiplexed with the R-ESCH, for example, the multiplexed signal is demultiplexed at 110 to recover the R-RICH.

After demultiplexing at 110, recovered communication signals may be further processed. In one embodiment, control information is decoded from one such recovered signal, to determine MCS information from Walsh codes for instance. Once the control information is successfully decoded, all the inserted pieces of the control information are known and can be accumulated or otherwise processed for channel estimation and decoding of other communication signals, for example. In the above example of FIG. 5, the R-RICH is recovered in blocks of 128 chips at a time and may be effectively re-used as a pilot channel when a complete code sequence or symbol of 4 codes, in 2 128-chip blocks, has been decoded. According to a preferred embodiment, the recovered R-RICH is used in conjunction with the common pilot R-PICH for channel estimation and decoding of the R-ESCH. When R-ESCH is transmitting at a variable data rate, additional known pilot-only bits may be punctured into R-ESCH to improve the receiver performance. The number and the position of these additional punctured pilot-only bits for each rate are predetermined and specified. Once the receiver decodes R-RICH, it is then able to extract the additional pilot bits from their punctured positions and use them with the R-RICH and R-PICH as a pilot reference during decoding of R-ESCH.

As described above, control information that is multiplexed with a communication signal may include information from a control channel such as R-RICH or predetermined, known control information referred to generally herein as pilot-only information. For pilot-only embodiments, a TDM pilot channel can readily be combined with the common pilot R-PICH to decode the R-ESCH, since the pilot-only information is known. When R-ESCH is transmitting at a variable data rate, the amount of TDM pilot information that is inserted into the R-ESCH can vary according to each data rate. The positions and the amount of puncturing for each R-ESCH data rate are predetermined and specified. A receiver preferably first decodes the separate CDM R-RICH to obtain data rate information, and once the data rate information is obtained, the corresponding punctured positions and amount of pilot information is known.

Where punctured positions are not used for control information, other information such as data may be multiplexed with a communication signal. In this case, the other information is extracted from punctured positions substantially as described above.

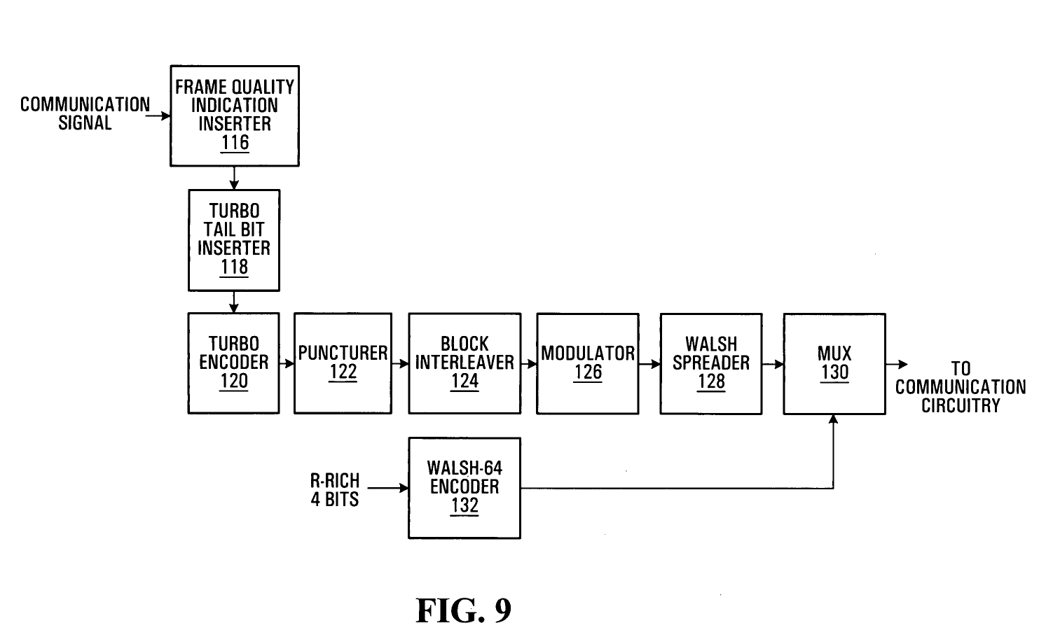

FIG. 9 is a block diagram of a system in accordance with an embodiment of the invention. The system shown in FIG. 9 is implemented at a transmitter to insert information into a communication signal, and includes a frame quality indication inserter 116, a turbo tail bit inserter 118, a turbo encoder 120, a puncturer 122, a block interleaver 124, a modulator 126, a Walsh spreader 128, a multiplexer (MUX) 130, and a Walsh encoder 132. Although shown as separate blocks, the components in FIG. 9 may be implemented in software code which is executed by a dedicated or general-purpose processor in a communication device. One example of a dedicated processor is a DSP (Digital Signal Processor), whereas a general-purpose processor may execute operating system software and/or software applications, for instance, in addition to signal processing software.

It should be apparent that the invention is in no way limited to systems in which the particular components shown in FIG. 9 have been implemented. Embodiments of the invention may be adapted to systems with further, fewer, and different components than those shown. For example, although frame quality indication and tail bit insertion, turbo encoding, block interleaving, modulation, and spreading represent signal processing operations that are typically performed in particular types of communication systems, implementation of embodiments of the invention is not dependent upon any of these operations. Thus, embodiments of the invention may be applied to different communication signal paths than the signal path shown in FIG. 9.

Those skilled in the art will appreciate from the foregoing that the puncturer 122, the multiplexer 130, and the Walsh-64 encoder 132 where control information is to be coded before multiplexing, are directly involved in the techniques described herein. The other components 116, 118, 120, 124, 126, and 128 are common in communication devices which will be familiar to those skilled in the art to which the present invention pertains and as such will not be described in detail.

According to one embodiment of the invention, the puncturer 122 and the multiplexer 130 are inserted into a communication signal path between a signal generator which generates communication signals to be transmitted and communication circuitry which transmits the communication signals. In the illustrative example system of FIG. 9, the communication signal path includes the components 116, 118, 120, 124, 126, and 128. As their names imply, the frame quality indication inserter 116 and turbo tail bit inserter 118 add quality information and tail bits to a communication signal. The turbo encoder 120 encodes the resultant signal.

The puncturer 122 punctures the turbo encoded signal as described above, preferably to create a TDM control information channel within the signal. The block interleaver 124 interleaves blocks of the punctured signal and outputs the interleaved signal to the modulator 126, which may use any of a plurality of modulation techniques, such as BPSK (Binary Phase Shift Keying), QPSK (Quadrature PSK), 8PSK, and QAM (Quadrature Amplitude Modulation) for instance. The modulated signal is then spread onto codes by the Walsh spreader 128. The Walsh-64 encoder 132 similarly spreads or maps 4 bits of R-RICH information to 64-bit Walsh codes. The coded R-RICH bits are then multiplexed with the output from the Walsh spreader 128 by the multiplexer 130. As described above, the Walsh codes to which the R-RICH bits are mapped are inserted into punctured positions of the communication signal. The multiplexed signal is provided to communication circuitry, which may store the signal for later transmission or further process the signal for transmission, for example. In a CDMA system for instance, the multiplexed signal is output to a combiner to be combined with other signals which are encoded using different codes. The Walsh spreader 128 and the Walsh-64 encoder 132 use the same Walsh code branch in a preferred embodiment of the invention.

The system of FIG. 9 represents one illustrative example of a communication signal path in which two different multiplexing techniques are interspersed. A multiplexing technique according to an aspect of the invention involves puncturing a signal at the puncturer 122 using a TDM scheme and then inserting information into punctured positions at the multiplexer 130. Where the system in FIG. 9 is a CDMA system, communication signals are spread onto different codes and then combined by a combiner (not shown) in the communication circuitry. For the communication signal with which the R-RICH is multiplexed, spreading is performed by the Walsh spreader 128.

Thus, in the system of FIG. 9, each of two different multiplexing techniques includes multiple operations, puncturing/inserting and spreading/combining, which are interspersed. It should be appreciated, however, that the multiplexing techniques or operations may be performed in a different order than shown in FIG. 9. For example, a communication signal with which control information or some other signal is to be multiplexed as described herein may be a multiplexed signal to which one multiplexing technique has already been applied, or a signal intended to be multiplexed with further communication signals using the multiplexing technique after it has been multiplexed with the control information or signal using a different multiplexing technique.

Although only one communication signal path has been shown in FIG. 9, a transmitter preferably includes multiple signal paths which process different communication signals that are or will be multiplexed for transmission. A shared communication signal path is also contemplated, wherein multiple communication signals are processed by common components. In such an embodiment of the invention, the puncturer 122 and the multiplexer 130 are preferably only active when the signal path is processing the communication signal with which the R-RICH is to be multiplexed.

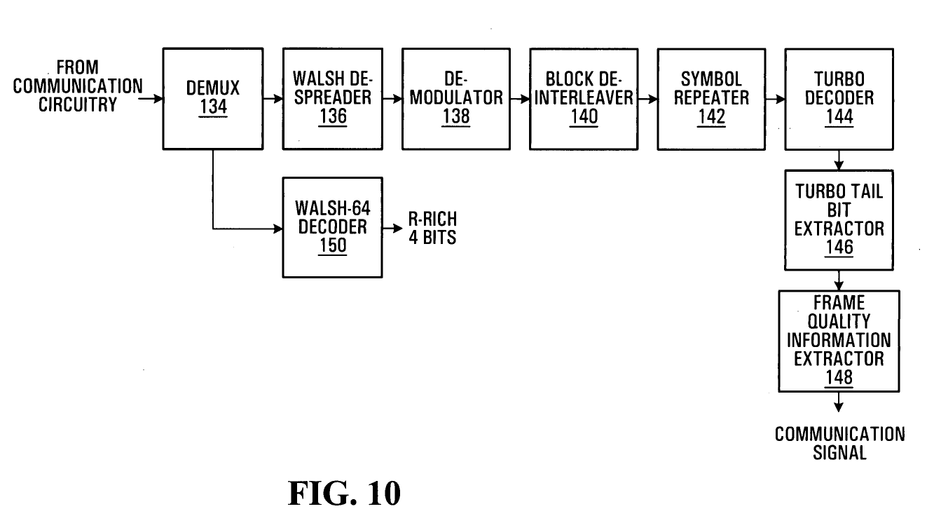

FIG. 10 is a block diagram of a system in accordance with another embodiment of the invention, for a receiver. The system includes a demultiplexer (DMUX) 134, a Walsh de-spreader 136, a demodulator 138, a block de-interleaver 140, a symbol repeater 142, a turbo decoder 144, a turbo tail bit extractor 146, a frame quality indication extractor 148, and Walsh decoder 150. As described above in conjunction with FIG. 9, it should be apparent that the invention is in no way limited to systems in which the particular components shown in FIG. 10 are provided.

The operation of the system of FIG. 10 will be apparent from the foregoing. A received multiplexed signal including signals that have been multiplexed according to different multiplexing techniques is demultiplexed by the demultiplexer 134. In the example of FIG. 10, 4-bit R-RICH information is decoded by the decoder 150. The decoded R-RICH information is then used as described above for channel estimation and further processing of the received signal, such as in a RAKE receiver for CDMA communications.

The demultiplexing by the demultiplexer 134 is according to a demultiplexing technique which corresponds to the multiplexing technique applied by the multiplexer 130 (FIG. 9). Further demultiplexing of a received multiplexed signal may be performed in a communication signal path before or after the demultiplexer 134. Demultiplexing operations for different demultiplexing techniques may also be interspersed. For CDMA communications, for example, a received demultiplexed signal may be processed by a signal splitter in the communication circuitry, demultiplexed by the demultiplexer 134, and then de-spread by the de-spreader 136. Signal splitting and de-spreading are demultiplexing operations involved one demultiplexing technique, and demultiplexing by the demultiplexer 134 is according to a different demultiplexing technique, illustratively TDM.

Those skilled in the art will be familiar with the components 136, 138, 140, 144, 146, and 148 and their operation. The symbol repeater 142 is an optional component which repeats symbols or parts thereof to fill punctured positions of a received signal from which the R-RICH information has been extracted by the demultiplexer 134.

The systems of FIGS. 9 and 10 are preferably implemented at a communication terminal configured for operation in a communication network and a network element of the communication network, such as a base station or transceiver station that supports RL, also referred to as uplink, communications from the communication terminal to the network element. Where the techniques described herein are to be implemented for reverse and forward (or down) links, such systems are preferably provided at both a network element and a communication terminal.

According to a further aspect of the invention, the power allocated to the R-ESCH, and thus the punctured channel multiplexed with the R-ESCH, is controlled based on the power of other channels with which the R-ESCH is multiplexed or combined. In a CDMA system, for example, communication signals carried by multiple channels are encoded and then combined for transmission. In a preferred embodiment, the R-ESCH with the embedded punctured channel is one of these multiple channels.

An R-ESCH power control scheme may, for example, be defined to reduce the PAR (Peak to Average Ratio) of transmitted signals. The power levels of other signals with which the R-ESCH is to be combined are determined, and the power level of the R-ESCH is then set accordingly, such as at a lower power level when the other signals are at a relatively high power level, and at a higher power level when the other signals are at a relatively low power level. Peak signal levels are thereby reduced while average signal levels are increased, with the overall effect of reducing PAR. Power level thresholds and adjustments may be dependent upon one or more transmitter characteristics such as total available transmitter power and the power control scheme to be implemented. Control of signal power according to a power control scheme may be realized, for example, through a controllable gain component.

Other types of power control schemes are also possible, for instance to maximize R-ESCH power for high data rates.

Numerous modifications and variations of the present invention are possible in light of the above teachings. It is therefore to be understood that within the scope of the appended claims, the invention may be practiced otherwise than as specifically described herein.

For example, embodiments of the invention have been described above primarily in the context of an embedded punctured TDM pilot channel multiplexed with the R-ESCH for carrying information from the R-RICH. This does not prevent other information, including data, from being embedded into the punctured channel. The invention is also not limited to these channels, TDM techniques, or reverse link communications.

TABLE 1
Summary of reverse link channels

| | Channel Type | Maximum # |
|---|---|---|
| | Reverse Pilot Channel | 1 |
| | Access Channel | 1 |
| | Enhanced Access Channel | 1 |
| | Reverse Common Control Channel | 1 |
| | Reverse Dedicated Control Channel | 1 |
| | Reverse Acknowledgment Channel | 1 |
| | Reverse Channel Quality Indicator | 1 |
| | Channel | |
| | Reverse Fundamental Channel | 1 |
| | Reverse Supplemental Code Channel (RC 1 | 7 |
| | and 2 only) | |
| | Reverse Supplemental Channel (RC 3 and | 2 |
| | 4 only) | |
| New | Reverse Enhanced Supplemental Channel | 2 |
| channels | (RC7 only) (R-ESCH) | |
| added to | Reverse Rate Request Channel (R-RRCH) | 1 |
| support R- | Reverse Rate Indicator Channel (R-RICH) | 2 |
| ESCH | Reverse H-ARQ Indicator Channel | 2 |
| operation | (R-HICH) | |

TABLE 2
Walsh coded symbols

| | |
|---|---|
| MCS | Coded Symbols |

| | | | | |
|---|---|---|---|---|
| MCS-0 (0000) | W₆₄ | W₆₄ | W₆₄ | W₆₄ |
| MCS-1 (0001) | W₆₄ | W₆₄ | W₆₄ | −W₆₄ |
| MCS-2 (0010) | W₆₄ | W₆₄ | −W₆₄ | W₆₄ |
| MCS-3 (0011) | W₆₄ | W₆₄ | −W₆₄ | −W₆₄ |
| MCS-4 (0100) | W₆₄ | −W₆₄ | W₆₄ | W₆₄ |
| MCS-5 (0101) | W₆₄ | −W₆₄ | W₆₄ | −W₆₄ |
| MCS-6 (0110) | W₆₄ | −W₆₄ | −W₆₄ | W₆₄ |
| MCS-7 (0111) | W₆₄ | −W₆₄ | −W₆₄ | −W₆₄ |
| MCS-8 (1000) | −W₆₄ | W₆₄ | W₆₄ | W₆₄ |
| MCS-9 (1001) | −W₆₄ | W₆₄ | W₆₄ | −W₆₄ |
| MCS-10 (1010) | −W₆₄ | W₆₄ | −W₆₄ | W₆₄ |
| MCS-11 (1011) | −W₆₄ | W₆₄ | −W₆₄ | −W₆₄ |
| MCS-12 (1100) | −W₆₄ | −W₆₄ | W₆₄ | W₆₄ |
| MCS-13 (1101) | −W₆₄ | −W₆₄ | W₆₄ | −W₆₄ |
| MCS-14 (1110) | −W₆₄ | −W₆₄ | −W₆₄ | −W₆₄ |
| MCS-15 (1111) | −W₆₄ | −W₆₄ | −W₆₄ | −W₆₄ |

1. A method comprising:
multiplexing a first communication signal with a second communication signal according to a first multiplexing technique; and
multiplexing the first communication signal with a third communication signal according to a second multiplexing technique.

2. The method of claim 1, wherein multiplexing the first communication signal with the third communication signal precedes multiplexing the first communication signal with the second communication signal, whereby the multiplexed first communication signal and third communication signal are multiplexed with the second communication signal.

3. The method of claim 1, wherein the second multiplexing technique comprises at least a first multiplexing operation and a second multiplexing operation, wherein the first multiplexing operation has been performed on the second and third communication signals, and wherein multiplexing the second communication signal with the third communication signal comprises performing the second multiplexing operation.

4. The method of claim 1, wherein the first multiplexing technique comprises at least a first multiplexing operation and a second multiplexing operation, wherein the second multiplexing technique comprises at least a first multiplexing operation and a second multiplexing operation, and wherein the first and second multiplexing operations of the first multiplexing technique are interspersed with the first and second multiplexing operations of the second multiplexing technique.

5. The method of claim 1, wherein the first multiplexing technique comprises:
puncturing the first communication signal at a plurality of time positions; and
inserting portions of the second communication signal into the punctured positions.

6. The method of claim 5, wherein puncturing comprises puncturing at a puncturing ratio selected from the group consisting of: a fixed puncturing ratio and a variable puncturing ratio.

7. The method of claim 5, wherein inserting comprises:
inserting the portions of the second communication signal into a subset of the punctured positions; and
inserting portions of the third communication signal into unused punctured positions into which no portions of the second communication signal have been inserted.

8. The method of claim 5, further comprising:
puncturing the third communication signal at the plurality of time positions.

9. The method of claim 1, wherein the first communication signal is associated with a data channel, and wherein the second communication signal is associated with a pilot channel configured to carry pilot information for use in coherent detection of the data channel.

10. The method of claim 9, wherein the pilot information comprises predetermined information.

11. The method of claim 9, wherein the pilot information comprises channel configuration parameters of the data channel.

12. The method of claim 11, wherein the channel parameters comprise at least one parameter selected from the group consisting of: data rate and modulation type.

13. The method of claim 1, wherein the first, second, and third communication signals comprise CDM (code division multiplexing) signals, and wherein the first multiplexing technique comprises TDM (time division multiplexing).

14. The method of claim 13, wherein the first and second communication signals comprise respective information that has been spread onto Walsh codes in a common Walsh code branch.

15. The method of claim 1, further comprising:
determining a power level of the third communication signal; and
allocating a power level to the first communication signal and the second communication signal based on the power level of the third communication signal.

16. A computer-readable medium storing instructions which when executed by a processor perform the method of claim 1.

17. The method of claim 1, further comprising:
transmitting to a receiver a multiplexed signal comprising the first communication signal multiplexed with the second communication signal according to the first multiplexing technique and with the third communication signal according to the second multiplexing technique;
receiving the multiplexed signal at the receiver; and
demultiplexing the received multiplexed signal according to a demultiplexing technique corresponding to the first multiplexing technique to recover the second communication signal.

18. A method comprising:
receiving a multiplexed signal comprising a first communication signal multiplexed with a second communication signal according to a first multiplexing technique and with a third communication signal according to a second multiplexing technique; and
demultiplexing the multiplexed signal according to a demultiplexing technique corresponding to the first multiplexing technique to recover the second communication signal.

19. The method of claim 18, wherein the second communication signal comprises encoded control information associated with the first communication signal, further comprising:
decoding the encoded control information.

20. The method of claim 19, wherein the control information comprises pilot information for coherent detection of the first communication signal.

21. The method of claim 20, wherein the pilot information comprises known predetermined information.

22. The method of claim 20, wherein the pilot information comprises information associated with a pilot channel.

23. The method of claim 20, wherein the first, second, and third communication signals are associated with respective reverse link communication channels between a communication terminal and a network element in a communication network.

24. The method of claim 23, wherein the first communication signal is associated with an R-ESCH (Reverse Enhanced Supplemental Channel).

25. The method of claim 24, wherein the second communication signal is associated with an R-RICH (Reverse Rate Indicator Channel).

26. The method of claim 24, wherein the second communication signal is associated with an R-PDPICH (Reverse Packet Data Pilot Channel).

27. A computer-readable medium storing instructions which when executed by a processor perform the method of claim 18.

28. A system comprising:
an input for receiving first, second, and third communication signals; and
a processor configured to multiplex the first communication signal with the second communication signal according to a first multiplexing technique and to multiplex the first communication signal with the third communication signal according to a second multiplexing technique.

29. The system of claim 28, wherein the first, second, and third communication signals are CDM (code division multiplexing) signals, wherein the first multiplexing technique is TDM (time division multiplexing), and wherein the second multiplexing technique is CDM.

30. The system of claim 29, wherein the processor implements a puncturer configured to puncture the first communication signal at a plurality of time positions and a multiplexer configured to insert portions of the second communication signal into the punctured positions.

31. The system of claim 30, wherein the processor further implements an encoder configured to encode the portions of the second communication signal, and wherein the multiplexer is further configured to insert the encoded portions of the second communication signal into the punctured positions.

32. The system of claim 31, wherein the first communication signal comprises information encoded using a Walsh coding branch, and wherein the encoder is configured to encode the portions of the second communication signal using the Walsh coding branch.

33. The system of claim 28, wherein the processor implements a power controller configured to determine a power level of the third communication signal, and to control a power level of the first communication signal and the second communication signal based on the power level of the third communication signal.

34. The system of claim 28, implemented in a communication terminal in a communication network, the communication network further comprising a network element, wherein the processor is further configured to transmit to the network element a multiplexed signal comprising the first communication signal multiplexed with the second communication signal according to the first multiplexing technique and with the third communication signal according to the second multiplexing technique, and wherein the network element comprises:
an input for receiving the multiplexed signal; and
a processor configured to demultiplex the received multiplexed signal according to a demultiplexing technique corresponding to the first multiplexing technique to recover the second communication signal,
whereby multiplexing of signals according to the first and second multiplexing techniques is supported for reverse link communications between the communication terminal and the network element.

35. The system of claim 28, implemented in a network element of a communication network, the communication network further comprising at least one communication terminal, wherein the processor is further configured to transmit to the communication terminal a multiplexed signal comprising the first communication signal multiplexed with the second communication signal according to the first multiplexing technique and with the third communication signal according to the second multiplexing technique, and wherein the communication terminal comprises:
an input for receiving the multiplexed signal; and
a processor configured to demultiplex the received multiplexed signal according to a demultiplexing technique corresponding to the first multiplexing technique to recover the second communication signal,
whereby multiplexing of signals according to the first and second multiplexing techniques is supported for forward link communications between the network element and the communication terminal.

36. The system of claim 28, implemented in both a communication terminal and a network element in a communication network, wherein:
the processors in the communication terminal and the network element are further configured to transmit to the network element and the communication terminal, respectively, a multiplexed signal comprising the first communication signal multiplexed with the second communication signal according to the first multiplexing technique and with the third communication signal according to the second multiplexing technique;
the inputs in the communication terminal and the network element are further configured to receive the multiplexed signal from the network element and the communication terminal, respectively, and
a processors in the communication terminal and the network element are further configured to demultiplex the received multiplexed signal according to a demultiplexing technique corresponding to the first multiplexing technique to recover the second communication signal,
whereby multiplexing of signals according to the first and second multiplexing techniques is supported for both reverse link communications between the communication terminal and the network element and forward link communications between the network element and the communication terminal.

37. A system comprising:
an input for receiving a multiplexed signal comprising a first communication signal multiplexed with a second communication signal according to a first multiplexing technique and with a third communication signal according to a second multiplexing technique; and
a processor configured to demultiplex the multiplexed signal according to a demultiplexing technique corresponding to the first multiplexing technique to recover the second communication signal.

38. The system of claim 37, wherein the second communication signal comprises encoded control information associated with the first communication signal, and wherein the processor is further configured to decode the encoded control information and to further process the multiplexed signal using the control information.

39. The system of claim 38, wherein the control information comprises information indicating a data rate of the first communication signal.

40. A communication channel structure comprising:
a first communication channel having punctured positions forming a punctured communication channel multiplexed with the first communication channel according to a first multiplexing technique;
a second communication channel; and
a third communication channel,
wherein information from the second communication channel is inserted into the punctured communication channel, and wherein the first and third communication channels are adapted for multiplexing according to a second multiplexing technique.

41. The structure of claim 40, wherein the first, second, and third communication channels are CDM (code division multiplexing) channels, wherein the first multiplexing technique is TDM (time division multiplexing), and wherein the second multiplexing technique is CDM.

42. The structure of claim 40, wherein the third communication channel comprises punctured positions corresponding to the punctured positions of the first communication signal, and wherein the third communication channel assumes a DTX (discontinued transmission) state at the punctured positions.

43. The structure of claim 41, wherein the first, second, and third communication channels comprise reverse link communication channels between a communication terminal and a communication network element in a communication system.

44. The structure of claim 43, wherein the first communication channel comprises an R-ESCH (Reverse Enhanced Supplementary Channel).

45. The structure of claim 44, wherein the second communication channel is selected from the group consisting of: an R-RICH (Reverse Rate Indicator Channel) and an R-PDPICH (Reverse Packet Data Pilot Channel).

46. The structure of claim 44, wherein the R-ESCH is a variable frame size channel having a plurality of frames, each frame comprising a plurality of time slots, wherein the punctured positions comprise at least one punctured position per time slot.

47. The structure of claim 46, wherein the information from the second communication channel comprises a coded symbol, and wherein the coded symbol is inserted into a plurality of punctured positions in adjacent time slots of the first communication signal.

48. The structure of claim 47, wherein the coded symbol inserted into the punctured positions of a frame of the R-ESCH encode a data rate of a next frame of the R-ESCH.

49. The structure of claim 48, wherein the coded symbol encodes 4 information bits which indicate one of 16 different MCS (Modulation Coding Set)/data rates.

50. The structure of claim 47, wherein the coded symbol is repeated in the punctured positions.
